(19) United States
(12) Patent Application Publication
(10) Pub. No.: US 2010/0067331 A1
(43) Pub. Date: Mar. 18, 2010

(54) ITERATIVE CORRELATION-BASED EQUALIZER FOR UNDERWATER ACOUSTIC COMMUNICATIONS OVER TIME-VARYING CHANNELS

(76) Inventor: Tsih C. Yang, Great Falls, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/548,789

(22) Filed: Aug. 27, 2009

Related U.S. Application Data
(60) Provisional application No. 61/096,658, filed on Sep. 12, 2008.

(51) Int. Cl. H04B 11/00

(52) U.S. Cl. 367/134

(57) ABSTRACT

Underwater communications apparatus and methods are presented using iterative correlation-based equalization in which initial estimated symbols of a current data block are produced using a correlation-based equalizer (CBE) based at least partially on the received sound transmissions of the current data block and an estimated channel impulse response (CIR) of a previous data block, the CIR of the current data block is estimated using the initial estimated symbols, and re-estimated symbols of the current data block are produced using a CBE based on the estimated CIR, and the estimated symbol having the lowest error is selected as the received data.

### REFERENCE TO RELATED APPLICATION

This application claims priority to and the benefit of U.S. Provisional Patent Application Ser. No. 61/096,658, filed Sep. 12, 2008, entitled SEMI-CONTINUOUS UNDERWATER ACOUSTIC COMMUNICATIONS OVER TIME-VARYING CHANNELS, the entirety of which is hereby incorporated by reference.

### FIELD OF THE DISCLOSURE

The present disclosure relates generally to underwater acoustic communications and more particularly to receiver apparatus and methods for semi-continuous underwater acoustic communications over time-varying channels.

### BACKGROUND

Underwater acoustic communications bandwidth is affected by high channel attenuation, extended multipath arrivals spanning over tens to hundreds of symbols, and rapidly channel variations resulting in loss of signal coherence. Shallow water, for instance, is complex, with different sound speed profiles and different bottoms, resulting in a range-dependent multipath arrival structure which varies from site to site. Eddies, internal waves, and turbulence may also be present, and as a result the propagation condition can change significantly over a short period of time. This imposes a significant challenge to receiver apparatus which must track the channel variations (either explicitly or implicitly) in order to remove time-varying inter-symbol interference (ISI). Signal processing that incorporates the channel physics may be used to mitigate environmental effects, and alternatively error correction codes may be employed in turbo equalization to minimize the bit error rate (BER). Turbo equalization, however, requires extensive computational resources which are impractical in many applications, such as battery powered acoustic modems. Using powerful encoder technology results in a significantly reduced data rate. Passive or active time reversal techniques are robust with respect to multipath arrivals when a large number of receivers are used in time-invariant channels, where passive time reversal is also known as passive-phase conjugation (PPC). Time varying channels can be compensated by channel re-estimation also using a large aperture vertical receiver array with many receivers covering a large portion of the water column through high spatial diversity. However, practical underwater acoustic modems are limited to a small aperture receiver array supporting only a small number of receivers (acoustic transducers), and therefore require additional signal processing to remove the inter-symbol interference and reduce the bit error rate. Thus far, attempts to improve data rate in underwater systems having a small number of receivers have focused on multichannel decision-feedback equalizers (DFEs), but different environments, having different multipath arrivals, require different parameter settings (different numbers of DFE tap coefficients), and the sensitivity of this approach to changing environmental conditions is particularly troublesome at high frequencies above 15 kHz, makes an autonomous operation difficult. In an attempt to overcome this limitation, a small number of properly configured receivers with spatial diversity can be used with a pre-processor using PPC, followed by a single-channel DFE, referred to as a correlation-based equalizer (CBE), and has been applied to moving-source data at mid frequencies (2-5 kHz). (It has been shown that time reversal performance is inferior to that of a multichannel DFE, and can be improved by an equalizer). CBE has also been applied to mid frequency data, with adaptive weighting of sensor contributions to improve the PPC performance, where the channel at mid-frequencies can be considered as semi-stationary for the duration of a packet, since the channel coherence time is normally longer than the packet length. The CBE approach has also been generalized to include decision-directed channel-estimation (DD-CE) method for time-varying environments using hard decision symbols with data at 12 kHz using large (15-45 m) aperture arrays, but the channel estimation quality and BER performance degrade when the channel variation is severe as is found for high frequencies above about 15 kHz, and these shortcomings are further exacerbated when the array aperture is limited to less than about 2 m. Accordingly, developments are desired to improve the data rate and reduce the BER for underwater acoustic communications, particularly for high frequencies in time-varying channel conditions, and when small receiver array apertures are used to facilitate practical high bandwidth undersea communications. The above mentioned difficulties have limited the current transmission packet lengths to approximately 10 kilo-symbols or less, beyond which the DFE often fails to track the channel variations, and the resulting errors propagate and become intolerable. Even though the burst rate is high, the average data rate is significantly lower in comparison.

### SUMMARY OF DISCLOSURE

Various details of the present disclosure are hereinafter summarized to facilitate a basic understanding, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter. Improved receiver apparatus and methods are presented that facilitate high data rate and reduced BER performance for high frequency underwater acoustic communications, and which can be applied in time-varying channel conditions with small receiver array apertures with limited numbers of receiver transducers. The disclosed receiver apparatus provides iterative channel estimation (CE) and correlation-based equalization (CBE) using soft decision symbols to provide an iterative correlation-based equalizer or ICBE, and promises improved performance at high frequency data rates, such as 15-21 kHz for high input signal-to-noise (SNR) cases in underwater conditions having channel variations caused by rough sea surfaces, internal waves, and sources changing range, etc. The iterative correlation-based equalization concepts disclosed herein may be advantageously employed to use soft decision symbols to estimate the channel condition to facilitate reliable transmission of long data packets or blocks with low BER in harsh environments where the channel coherence time is very short relative to the packet length.

An iterative correlation-based equalization method of underwater communications is disclosed, which includes receiving acoustic underwater transmissions representing symbols grouped as data blocks and producing initial estimated symbols of a current data block using a correlation-based equalizer based at least partially on the received sound transmissions of the current data block and an estimated channel impulse response associated with a previous data block. The method further includes estimating a channel impulse response (CIR) associated with the current data block based at least partially on the received sound transmissions and the initial estimated symbols of the current data block, and producing re-estimated symbols of the current data block using a correlation-based equalizer based at least partially on the received sound transmissions and the estimated channel impulse response associated with the current data block. For each symbol of the current data block, one of the estimated symbol and the re-estimated symbol is selected having the lowest decision error as a received data symbol. In certain embodiments, production of the initial estimated symbols involves pre-processing the received sound transmissions of the current data block using passive phase conjugation according to the estimated CIR associated with the previous data block, and producing the initial estimated symbols using decision feedback equalization based at least partially on the pre-processed sound transmissions using a set of tap coefficients associated with the current data block. Producing the re-estimated symbols in certain embodiments includes pre-processing the received sound transmissions of the current data block using passive phase conjugation according to the estimated CIR associated with the current data block, and producing the re-estimated symbols of the current data block by decision feedback equalization based at least partially on the pre-processed sound transmissions using the set of tap coefficients associated with the current data block. In some embodiments, moreover, the iterative correlation-based equalization is performed two data blocks at a time.

An underwater communications system is disclosed, including one or more acoustic transducers that receive acoustic underwater transmissions representing symbols grouped as data block, as well as a processor system coupled with transducer. The processing system includes an iterative correlation-based equalizer (ICBE) that produces initial estimated symbols based at least partially on the received sound transmissions of a current data block and an estimated CIR of a previous data block. The ICBE estimates the CIR of the current data block using the initial estimated symbols, and produces re-estimated symbols of the current data block using correlation-based equalization based at least partially on the estimated CIR of the current data block. The ICBE selects one of the estimated symbol and the re-estimated symbol having the lowest decision error as a received data symbol.

In some embodiments, the iterative correlation-based equalizer includes a first correlation-based equalizer (CBE) component which produces the initial estimated symbols of the current data block based at least partially on the received sound transmissions of the current data block and the estimated channel impulse response associated with the previous data block, along with a channel estimation (CE) component that estimates the channel impulse response of the current data block based at least partially on the received sound transmissions and the initial estimated symbols of the current data block. The processing system in these embodiments also includes a second CBE component which produces the re-estimated symbols of the current data block based at least partially on the received sound transmissions and the CIR estimated for the current data block. The first CBE component in one embodiment is comprised of a passive phase conjugation (PPC) component to pre-process the received sound transmissions of the current data block according to the estimated CIR of the previous data block, as well as a DFE component that produces the initial estimated symbols of the current data block based at least partially on the pre-processed sound transmissions using a set of tap coefficients associated with the current data block. In certain embodiments, moreover, the second CBE component includes a second PPC to pre-process the received sound transmissions according to the CIR estimated for the current data block, along with a second DFE that produces the re-estimated symbols of the current data block based at least partially on the pre-processed sound transmissions using the set of tap coefficients associated with the current data block. The ICBE in various embodiments is operative to process two data blocks at a time.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIGS. 1A and 1B are partial side elevation views illustrating a surface ship and a remotely operated autonomous underwater vehicle (AUV) communicating via underwater acoustic communications systems employing one or more aspects of the present disclosure;

FIG. 2 is a schematic diagram illustrating an exemplary underwater acoustic transmitter/receiver communications system employing iterative correlation-based equalization in the surface ship and AUV of FIGS. 1A and 1B;

FIG. 3 is a schematic diagram illustrating an exemplary ICBE in the communications systems of FIGS. 1A, 1B, and 2;

FIG. 4 is a flow diagram illustrating an exemplary iterative correlation-based equalization method of underwater communications in accordance with the present disclosure; and

FIG. 5 is a schematic diagram illustrating iterative correlation-based equalization performed two data blocks at a time in the systems of FIGS. 1A-3.

### DETAILED DESCRIPTION OF THE DISCLOSURE

One or more embodiments or implementations are hereinafter described in conjunction with the drawings, where like reference numerals are used to refer to like elements throughout, and where the various features are not necessarily drawn to scale.

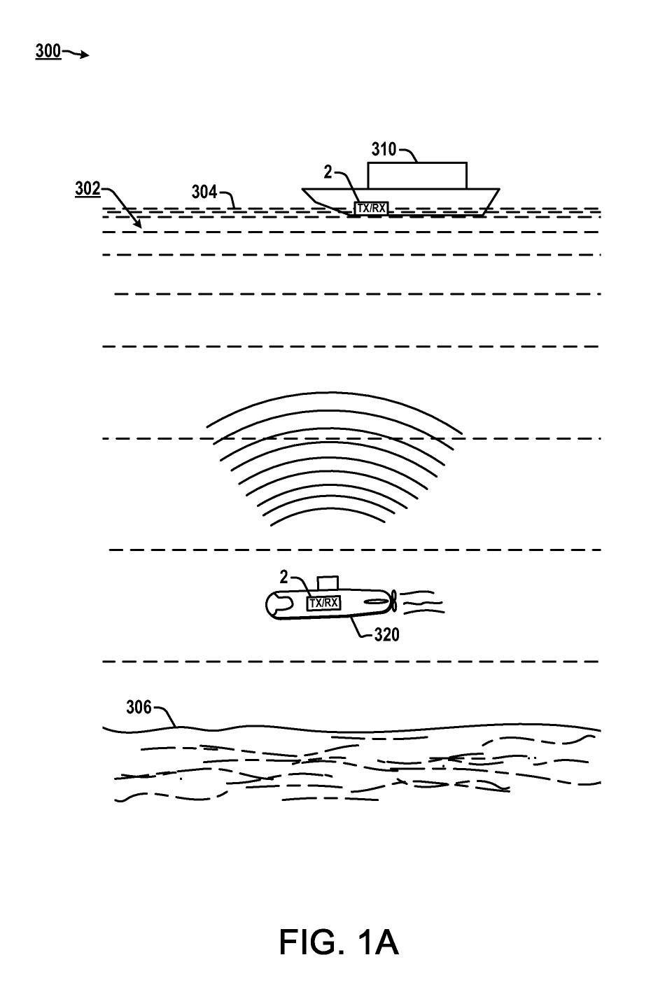

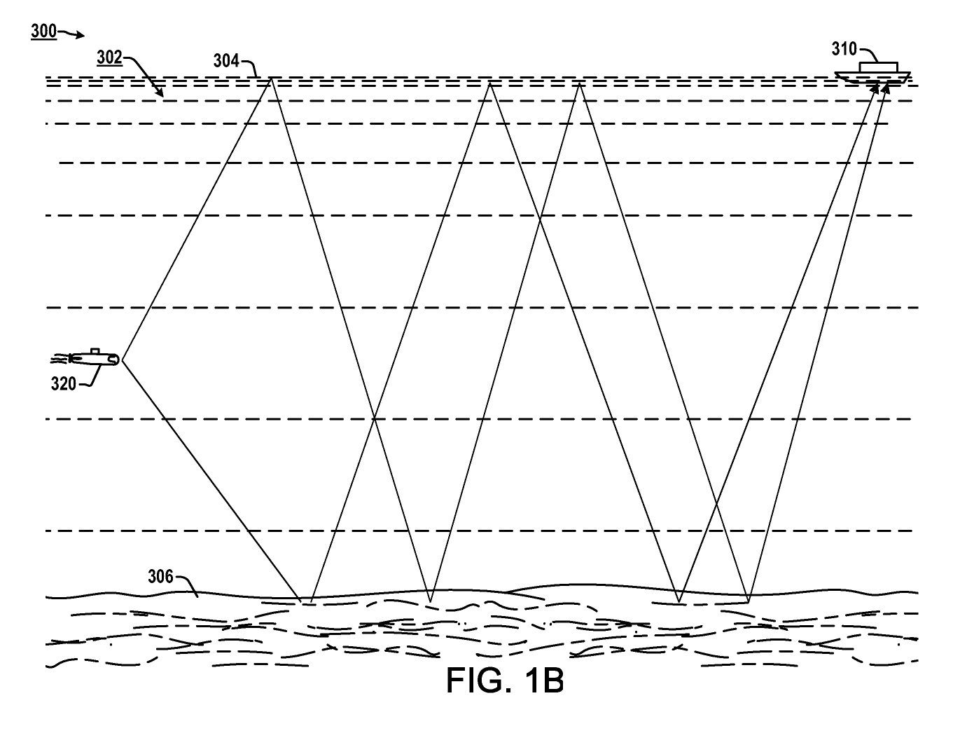

Referring initially to FIGS. 1A and 1B, an underwater communications environment 300 is illustrated in which various aspects of the present disclosure may be implemented. A surface ship 310 is illustrated at the surface 304 of a body of water 302 and the ship 310 is equipped with a transmitter/receiver (TX/RX) communications system 2 for sending and receiving data via acoustic transfer through the water 302 that forms an acoustic channel. An autonomous underwater vehicle (AUV), in one example, an unmanned submarine 320 is likewise equipped with a transmitter/receiver 2 for communication with the surface ship 310. The systems 2 allow the ship 310 and the AUV 320 to communication with one another over the water channel 302 at any relative locations between the sea surface 304 and the sea bottom 306. Underwater acoustic communications facilitate data exchange in a variety of applications, such as the ship-to-AUV situation in FIGS. 1A and 1B, as well as gathering data from a distributed field of remote sensors for environmental monitoring, and other situations in which cable-based communications are impractical or physically impossible. The exchange of large amounts of data via underwater acoustic communications is particularly desirable for transmitting underwater video images from the submarine 320 to the surface ship 310, and accordingly the present disclosure facilitates continuous or semi-continuous communications through the water channel 302 without need for cable connections and with the ability to combat communications errors in the presence of changing conditions in the water channel 302. While strictly vertical underwater data transmission is relatively straightforward, horizontal transmission can be very difficult due to the many multipaths as shown in FIG. 1B.

As the bandwidth of the underwater acoustic channel 302 is limited, the communications techniques must be efficient, and thus phase coherent modulations such as quadrature phase-shift-keying (QPSK) yielding a data rate of 2 bits/sec/Hz is preferably used in the disclosed embodiments. In this example, for a bandwidth of 20 kHz, a total data rate of 40 kbits/sec is possible, thereby opening the possibility of transmitting compressed video images from an underwater remote camera on the AUV 320 to the surface ship 310. The disclosed iterative correlation-based equalization techniques also facilitate adaptation to changing environmental conditions in the water channel 302 as the data source and receiver change range and depth, and as conditions vary from ocean to ocean, since different oceans have different sound speed profiles and different bottoms, resulting in different multipath arrival patterns. In particular, eddies, internal waves, turbulence, and rough sea surface can cause the propagation condition of a given channel 302 to change significantly over a short period of time. The channel 302, moreover, may include many scattered returns which are random and difficult to estimate and track. Thus, whereas some relatively stable arrivals may be modeled by an acoustic propagation model, others are random (scattered) due to sound scattering from rough ocean surfaces or water column inhomogeneities and are difficult to model. Moreover, communications in underwater applications often have other practical operating constraints, such as finite processing power. The ICBE techniques described herein advantageously use passive-phase conjugation to equalize the dominant arrivals and use direction adaptation decision feedback equalization to equalize the remaining ISI associated with the scattered returns, and improves performance by iterative adaptation allowing the equalizer to function over an extended period of time.

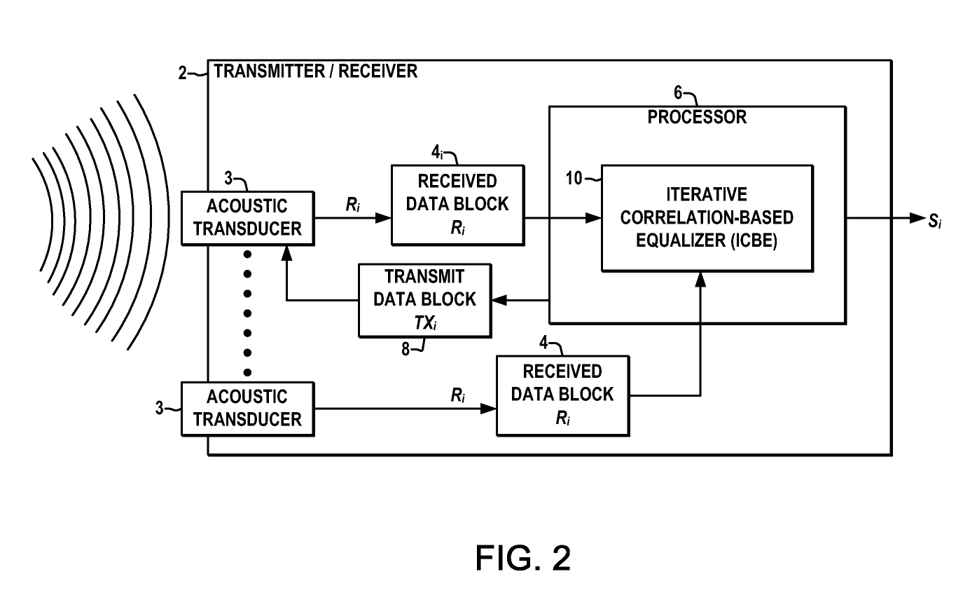

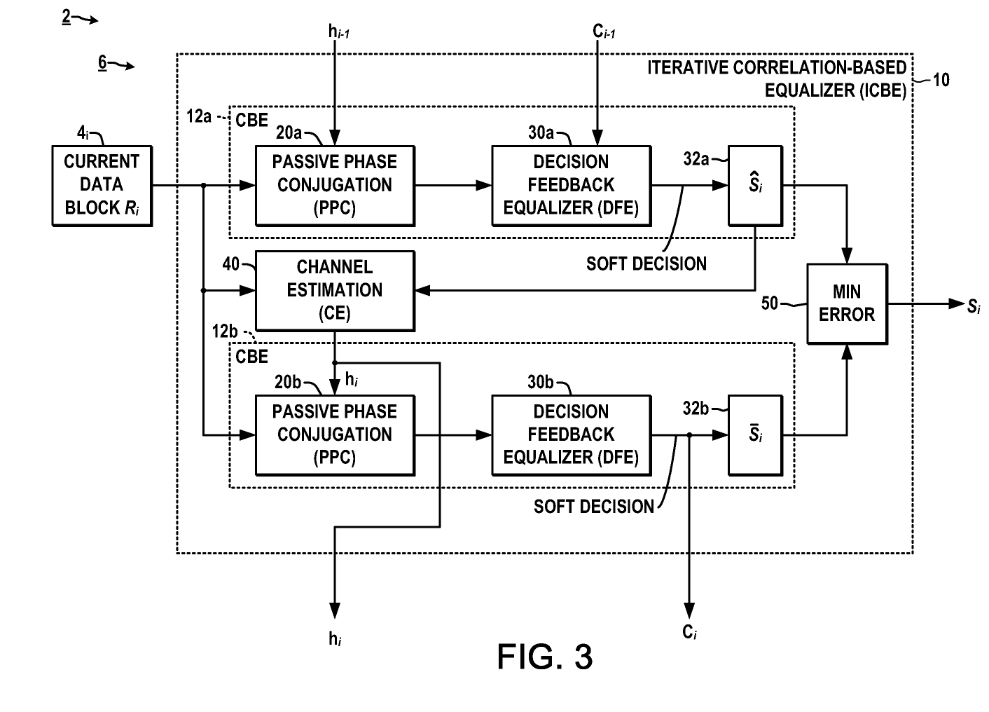

Referring now to FIGS. 2 and 3, the disclosed communications systems 2 and the methods described herein are adaptable to practical underwater acoustic communications applications, for example, using a single source transducer and a small number of receiver transducers. FIG. 2 illustrates an exemplary underwater acoustic transmitter/receiver communications system 2 employing iterative correlation-based equalization (ICBE) in the surface ship 310 and the AUV submarine 320 of FIGS. 1A and 1B. As seen in FIG. 2, the system 2 includes one or more acoustic transducers 3 individually operative to receive acoustic underwater transmissions from the water, where the transmissions represent symbols grouped as data blocks 4. A processor system 6 is coupled with the transducers 3 and includes an iterative correlation-based equalizer (ICBE) 10 operative to produce symbols Sᵢ based at least partially on the received sound transmissions Rᵢ of a current data block 4ᵢ. The exemplary system 2, moreover, allows transmission of one or more transmit data blocks TXᵢ 8 from the processor system 6 via one or more of the transducers 3. Suitable embodiments of the processor system 6 and the ICBE 10 thereof can include processor-based implementation configured or programmed to perform the communications functionality set forth herein, such as a microprocessor, microcontroller, DSP, programmable logic, along or in combination with suitable firmware, software, microcode, etc. In the example of FIG. 2, the processor system 6 is integrated into the transmitter receiver 2 in a common implementation along with the transducer components 3, but other systems 2 are possible in which the processor system 6 and the transducer(s) 3 are separately housed. The processor system 6 with its associated microprocessor or the like can operate by executing one or more sequences of one or more computer-readable instructions read into a memory of one or more computers/processors from volatile or non-volatile computer-readable media capable of storing and/or transferring computer programs or computer-readable instructions for execution by one or more computers/processors. Volatile computer readable media that can be used can include a compact disk, hard disk, floppy disk, tape, magneto-optical disk, PROM (EPROM, EEPROM, flash EPROM), DRAM, SRAM, SDRAM, or any other magnetic medium; punch card, paper tape, or any other physical medium. Non-volatile media can include a memory such as a dynamic memory in a computer. In addition, computer readable media that can be used to store and/or transmit instructions for carrying out methods described herein can include non-physical media such as an electromagnetic carrier wave, acoustic wave, or light wave such as those generated during radio wave and infrared data communications.

FIG. 3 illustrates further details of an exemplary ICBE 10 component in the communications systems 2 of FIGS. 1A, 1B, and 2, including first and second correlation-based equalizer (CBE) components 12a and 12b along with a channel estimation (CE) component 40 and a minimum error selection component 50. In operation, the first CBE component 12a produces initial estimated symbols 32a ( S) based at least partially on the received sound transmissions Rᵢ of a current data block 4ᵢ and an estimated CIR (hᵢ₋₁) of a previous data block 4ᵢ₋₁. The CE component 40 uses the initial estimated symbols 32a and received data block 4ᵢ to estimate the CIR hᵢ of the current data block 4ᵢ and provides this CIR estimate hᵢ to the second CBE component 12b. The second CBE component 12b produces re-estimated symbols 32b ( S̅ᵢ) of the current data block 4ᵢ based at least partially on the estimated CIR hᵢ, and the error selection component 50 selects one of the estimated symbol 32a and the re-estimated symbol 32b having the lowest decision error as a received data symbol Sᵢ for each symbol of the current block 4ᵢ. The first CBE component 12a in the illustrated example includes a passive phase conjugation (PPC) component 20a operative to pre-process the received sound transmissions Rᵢ of the current data block 4ᵢ according to the estimated CIR hᵢ₋₁ associated with the previous data block 4ᵢ, as well as a decision feedback equalizer (DFE) component 30a operative to produce the initial estimated symbols 32a based at least partially on the pre-processed sound transmissions using a set of tap coefficients Cᵢ₋₁ associated with the previous data block 4ᵢ₋₁. The second CBE component 12a includes a second PPC component 20b operative to pre-process the received sound transmissions Rᵢ of the current data block 4ᵢ according to the estimated CIR hᵢ associated with the current data block 4ᵢ, along with a second DFE component 30b operative to produce the re-estimated symbols 32b based at least partially on the pre-processed sound transmissions using the set of tap coefficients Cᵢ associated with the current data block 4ᵢ.

The individual CBE components 12 use estimated CIR information to apply passive-phase conjugation (PPC) to the received data Rᵢ, followed by a single-channel DFE. The DFE components 30 are known to be functional up to the channel coherence time during which the channel 302 can be assumed to be quasi-stationary. In order to communicate beyond the channel coherence time, the system 2 advantageously re-estimates the channel based on the soft decision data from the first DFE 30a. In a rapidly varying communications channel 302, the disclosed system 2 can operate on data are divided into blocks and the estimated CIR of the previous block is used to estimate the symbols of the current block via the CBE component 12a. The resulting soft decision symbols 32a are used with the current block of data Rᵢ to re-estimate the CIR via estimation component 40 and this estimated CIR is re-applied to the data Rᵢ to re-estimate the symbols 32b using the second CBE component 12b, and the process can be further iterated, although one iteration (e.g., two CBEs 12 as shown in FIG. 3) is often sufficient.

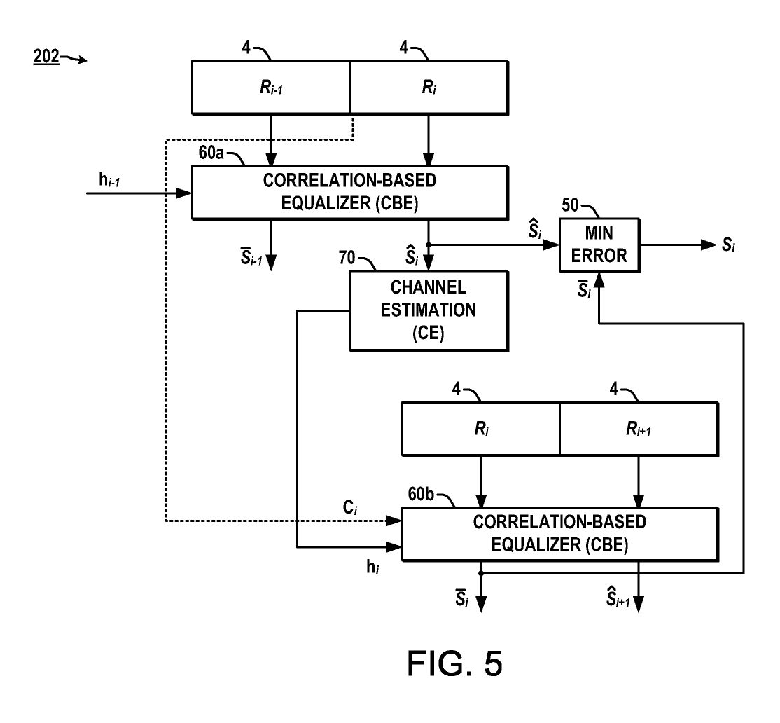

In using the ICBE-based system 2 for a time varying underwater channel 302 (FIGS. 1A and 1B), the data is preferably divided into blocks, each with a length less than or equal to the channel coherence time. However, the ICBE technique of the system 2 can be employed with data blocks of length longer than the channel coherence time, and may be advantageously employed to perform the iterative correlation-based equalization two data blocks 4ᵢ₋₁, 4ᵢ at a time, as further described below in connection with FIG. 5. For each block of data, the mean CIR may be known, such as by estimation from previously received blocks, and the ICBE technique thereafter refines the CIR estimation via the CE component 40 and applies CBE techniques via component 12b to estimate the transmitted symbols of the current block 4ᵢ. The hard decision symbols 32b of the current block 4ᵢ are then used to estimate the CIR of the current block which can be applied to the next block 4ᵢ₊₁. The channel estimation is thus improved by iterative application of correlation-based equalization for each block of data. Each improvement in channel estimation improves the equalization of the inter-symbol interference (ISI) due to the main arrivals using passive phase conjugation.

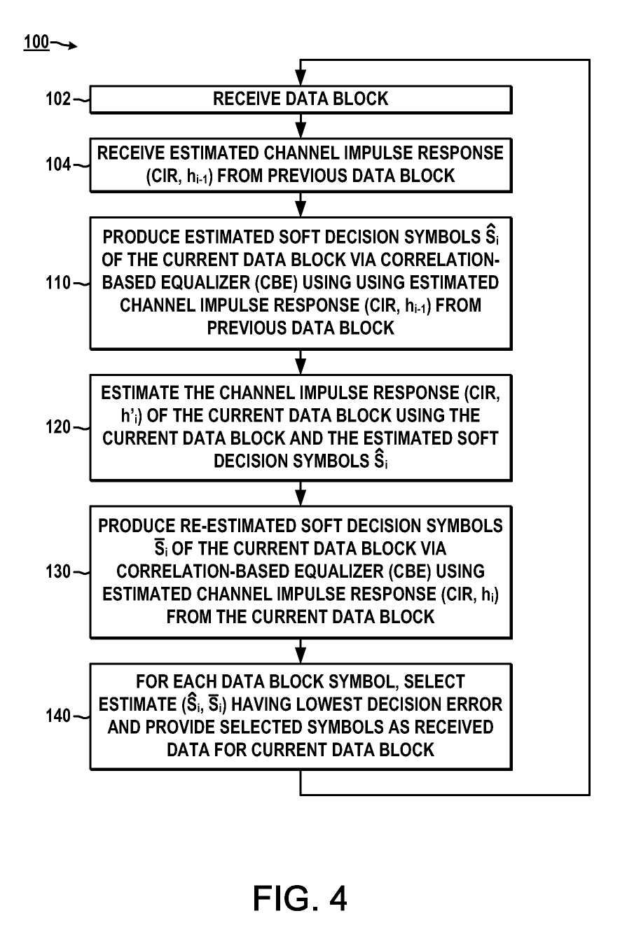

Referring also to FIG. 4, an exemplary method 100 is illustrated for iterative correlation-based equalization ICBE underwater communications, which can be implemented in the exemplary systems 2 or in other systems. Although the method 100 is illustrated and described below as a series of acts or events, it will be appreciated that the methods of the present disclosure are not limited by the illustrated ordering of such acts or events. In this regard, some acts or events may occur in different orders and/or concurrently with other acts or events apart from those illustrated and described herein, and that not all illustrated steps may be required to implement a process in accordance with the disclosure. The methods, moreover, may be implemented in association with the illustrated communications systems, messages, and apparatus, as well as with other systems, wherein all such alternatives are contemplated as falling within the scope of the present disclosure. The method 100 begins at 102 with receipt of a current data block, such as by receiving acoustic underwater transmissions Rᵢ representing symbols grouped as data blocks 4, as well as receiving an estimated CIR (hᵢ₋₁) associated with a previous data block 4ᵢ₋₁. At 110, initial estimated symbols 32a ( S̅ᵢ) of the current data block 4ᵢ are produced using a correlation-based equalizer (CBE 12a above) based at least partially on the received sound transmissions Rᵢ of the current data block 4ᵢ and the estimated CIR hᵢ₋₁ of the previous data block 4ᵢ₋₁. At 120, a CIR hᵢ is estimated for the current data block 4ᵢ based at least partially on the received sound transmissions Rᵢ and the initial estimated symbols 32a. At 130 re-estimated symbols 32b ( S̅ᵢ) are produced for the current data block 4ᵢ using a correlation-based equalizer (CBE 12b) based at least partially on the received sound transmissions Rᵢ and the estimated channel impulse response CIR hᵢ associated with the current data block 4ᵢ. For each symbol Sᵢ of the current data block 4ᵢ, the process 100 further includes selecting one of the estimated symbol 32a and the re-estimated symbol 32b having the lowest decision error as a received data symbol Sᵢ at 140, after which the process 100 is repeated for subsequent data blocks 4.

In one embodiment, the initial estimated symbols 32a are produced at 110 by pre-processing the received sound transmissions Rᵢ of the current data block 4ᵢ using passive phase conjugation (PPC 20a) according to the estimated CIR hᵢ₋₁ of the previous data block 4ᵢ₋₁, and producing the initial estimated symbols 32a with a DFE 30a based at least partially on the pre-processed sound transmissions using a set of tap coefficients Cᵢ associated with the previous data block 4ᵢ₋₁. In certain embodiments, moreover, producing the re-estimated symbols 32b at 130 includes pre-processing the received sound transmissions Rᵢ using passive phase conjugation PPC according to the estimated CIR hᵢ associated with the current data block 4ᵢ, and producing the re-estimated symbols 32b with a DFE 30b based at least partially on the pre-processed sound transmissions using the set of tap coefficients Cᵢ associated with the current data block 41.

The operation of the system 2 is depicted in FIGS. 2 and 3 for a single CBE iteration, although further iterations can be performed. The CIR estimated from the previous block (hᵢ₋₁) is used to pre-process the data using PPC 20a, followed by a single-channel DFE 30a. The DFE 30a in certain embodiments produces a block of estimated (soft) symbols Ŝᵢ, a block of candidate symbols [Ŝᵢ] based on decisions, and a symbol decision error Er(Ŝᵢ), represented as a vector with elements given by Er(ŝₙ)=|ŝₙ−[ŝₙ]|², where ŝₙ is the n^{th} element of the block vector Ŝᵢ. The symbol decision in this embodiment is based on a minimum Euclidean distance between the soft symbol and the true symbols with [ŝₙ]=arg min{[|ŝₙ−s₁|², |ŝₙ−s₂|², . . . |ŝₙ−s_{Q}|²}, where sᵢ, i=1, 2, . . . Q, are the symbol alphabets. The symbol decision can also be expressed in terms of probability distribution, [ŝₙ]=arg max{P_{b}(sₙ=s₁|ŝ), P_{b}(sₙ=s₂|ŝ), . . . P_{b}(sₙ=s_{Q}|ŝ)}, where P_{b}(sₙ=sᵢ|ŝ) denotes the probability of sₙ =sᵢ given ŝ. Er(Ŝᵢ) is the soft information for the symbol Ŝᵢ, and if the probability distribution is normal, then Er(sₙ) is the log-likelihood of the probability distribution.

The soft decision symbols [Ŝᵢ] are then used to re-estimate the CIR (hᵢ) of the current block 4i via the CE component 40, and assuming that hᵢ is an improvement over hᵢ₋₁, the re-estimated CIR is re-applied to the data in the second CBE component 12b to produce a new block of soft symbols, S̅ᵢ, a new block of candidate symbols [ S̅ᵢ], and a new symbol decision error vector Er( S̅ᵢ). For each symbol, the soft symbol having a lower decision error

sₙ=arg min{Er(ŝₙ), Er( s̅ₙ)},

Er(sₙ)=min{Er(ŝₙ), Er( s̅ₙ)}

is selected by the selection component 50 (at 140 in FIG. 4), resulting anew block of symbols Sᵢ=[s₁, s₁, . . . s_{M}], a new block of candidate symbols [Sᵢ], and a new symbol decision error vector Er(Sᵢ). In the case of a single iteration ICBE, the selected (minimum error) decision symbols [Sᵢ] are outputted as the final decision symbols of the current data block 4ᵢ. Otherwise, {Sᵢ, [Sᵢ], Er(Sᵢ)} becomes the {Ŝᵢ, [Ŝᵢ], Er(Ŝᵢ)} for the next iteration, and the process continues until the symbol error reaches an acceptable level or other termination conditions are satisfied. Below is an exemplary iteration algorithm for ICBE:

```
Initialization:
        H = hᵢ₋₁, C₀ = Cᵢ₋₁
        Y = matched_filter(H,R)
        {Ŝ,[Ŝ],C₀, Er(Ŝ)} <= DFE(C₀,Y)
for k = 1: K  % iteration number
    H <= CE(R,[Ŝ])
    Y = matched_filter(H,R)
    { S̅,[ S̅],C₀, Er( S̅)} <= DFE(C₀,Y)
    Ŝ <= arg min{Er(Ŝ),Er( S̅)}
    Er(Ŝ) <= min{Er(Ŝ),Er( S̅)}
end
```

[Sᵢ]=[Ŝ], hᵢ=H
Cᵢ=tap coefficients at the end of the last DFE

In one example, at the end of second iteration, the following are found:

sₙ=arg min{[Er(ŝₙ), Er( s̅ₙ)], Er( s̅ₙ)}=arg min{Er(ŝₙ), Er( s̅ₙ), Er( s̅ₙ)},

Er(sₙ)=min{[Er(ŝₙ), Er( s̅ₙ)], Er( s̅ₙ)}=min {Er(ŝₙ), Er( s̅ₙ), Er( s̅ₙ)}

where s̅ₙ is the soft symbol from a third DFE, n=1, 2, . . . M, and the decision is based on the minimum of the collective soft information.

Certain implementations of the method 100 may be implemented using a rough estimate of the channel coherence time to set the block size, such as by in situ estimation using a set of test signals, or determination from previously obtained channel coherence time information such as an archival database, where the channel temporal coherence as used herein is the normalized cross-correlation of a CIR with other CIRs, separated by a delay time and channel coherence time is the delay time for the temporal coherence to drop by a factor of 1/e.

Referring also to FIG. 5, in certain embodiments, the iterative correlation-based equalization ICBE can be performed two data blocks 4ᵢ₋₁, 4ᵢ at a time. In this implementation, first and second CBEs 60a and 60b are provided, each operating on two data blocks at a time, with a CE component 70 receiving the initial estimated symbols for the first block and using these to update the CIR hᵢ of the current block 4ᵢ. Two such dual-block stages are shown for implementing a single ICBE iteration, but any number of iterations may be done. In this embodiment, moreover, the tap coefficients Cᵢ used by the first DFE (at the beginning of block i) are saved to start the next DFE (of the next CBE) for the same block of data as shown by the dotted line, where the effective CIR values are given by:

$${\sum }_{j = 1}^{N} {\hat{h}}_{i - 1}^{*} • {h}_{i} and {\sum }_{j = 1}^{N} {\hat{h}}_{i}^{*} • {h}_{i} ,$$

for the first and second DFEs, which show less temporal variation than the effective CIRs of the hard decision case. For time-varying channels, multiple (e.g., uncorrelated) receivers may be used to mitigate signal fades using spatial diversity, where the number of receivers may be determined based on input SNR, the symbol constellation size, and the environments, and other considerations. Moreover, the ICBE can continue block by block by using the assumed prior knowledge of the CIR for each block, which it obtains, in practice, from iterations of channel-estimation and equalization, resulting in improved symbol estimation with minimal bit errors.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. An iterative correlation-based equalization method of underwater communications, comprising:
receiving acoustic underwater transmissions representing symbols grouped as data blocks;
producing initial estimated symbols of a current data block using a correlation-based equalizer based at least partially on the received sound transmissions of the current data block and an estimated channel impulse response associated with a previous data block;
estimating a channel impulse response associated with the current data block based at least partially on the received sound transmissions and the initial estimated symbols of the current data block; and
producing re-estimated symbols of the current data block using a correlation-based equalizer based at least partially on the received sound transmissions and the estimated channel impulse response associated with the current data block.

2. The method of claim 1, further comprising, for each symbol of the current data block, selecting one of the estimated symbol and the re-estimated symbol having the lowest decision error as a received data symbol.

3. The method of claim 2, wherein producing the initial estimated symbols of the current data block comprises:
pre-processing the received sound transmissions of the current data block using passive phase conjugation according to the estimated channel impulse response associated with the previous data block; and
producing the initial estimated symbols of the current data block with a decision feedback equalizer based at least partially on the pre-processed sound transmissions using a set of tap coefficients associated with the previous data block.

4. The method of claim 3, wherein producing re-estimated symbols of the current data block comprises:
pre-processing the received sound transmissions of the current data block using passive phase conjugation according to the estimated channel impulse response associated with the current data block; and
producing the re-estimated symbols of the current data block with a decision feedback equalizer based at least partially on the pre-processed sound transmissions using the set of tap coefficients associated with the current data block.

5. The method of claim 4, wherein the iterative correlation-based equalization is performed two data blocks at a time.

6. The method of claim 2, wherein the iterative correlation-based equalization is performed two data blocks at a time.

7. The method of claim 1, wherein producing the initial estimated symbols of the current data block comprises:
pre-processing the received sound transmissions of the current data block using passive phase conjugation according to the estimated channel impulse response associated with the previous data block; and
producing the initial estimated symbols of the current data block with a decision feedback equalizer based at least partially on the pre-processed sound transmissions using a set of tap coefficients associated with the previous data block.

8. The method of claim 7, wherein producing re-estimated symbols of the current data block comprises:
pre-processing the received sound transmissions of the current data block using passive phase conjugation according to the estimated channel impulse response associated with the current data block; and
producing the re-estimated symbols of the current data block with a decision feedback equalizer based at least partially on the pre-processed sound transmissions using the set of tap coefficients associated with the current data block.

9. The method of claim 8, wherein the iterative correlation-based equalization is performed two data blocks at a time.

10. The method of claim 1, wherein the iterative correlation-based equalization is performed two data blocks at a time.

11. An underwater communications system, comprising:
at least one acoustic transducer operative to receive acoustic underwater transmissions representing symbols grouped as data block; and
a processor system coupled with the at least one transducer and comprising an iterative correlation-based equalizer operative to produce initial estimated symbols based at least partially on the received sound transmissions of a current data block and an estimated channel impulse response of a previous data block, to estimate the channel impulse response of the current data block using the initial estimated symbols, to produce re-estimated symbols of the current data block using correlation-based equalization based at least partially on the estimated channel impulse response of the current data block, and to select one of the estimated symbol and the re-estimated symbol having the lowest decision error as a received data symbol.

12. The system of claim 11, wherein the iterative correlation-based equalizer comprises:
a first correlation-based equalizer component operative to produce the initial estimated symbols of the current data block based at least partially on the received sound transmissions of the current data block and the estimated channel impulse response associated with the previous data block;
a channel estimation component operatively coupled with the first correlation-based equalizer component to estimate the channel impulse response associated with the current data block based at least partially on the received sound transmissions and the initial estimated symbols of the current data block; and
a second correlation-based equalizer component operatively coupled with the channel estimation component to produce the re-estimated symbols of the current data block based at least partially on the received sound transmissions and the estimated channel impulse response associated with the current data block.

13. The system of claim 12, wherein the first correlation-based equalizer component comprises:
a passive phase conjugation component operative to pre-process the received sound transmissions of the current data block according to the estimated channel impulse response associated with the previous data block; and
a decision feedback equalizer component operative to produce the initial estimated symbols of the current data block based at least partially on the pre-processed sound transmissions using a set of tap coefficients associated with the previous data block.

14. The system of claim 13, wherein the second correlation-based equalizer component comprises:
a second passive phase conjugation component operative to pre-process the received sound transmissions of the current data block according to the estimated channel impulse response associated with the current data block; and
a second decision feedback equalizer component operative to produce the re-estimated symbols of the current data block based at least partially on the pre-processed sound transmissions using the set of tap coefficients associated with the current data block.

15. The system of claim 14, wherein the iterative correlation-based equalizer processes two data blocks at a time.

16. The system of claim 12, wherein the iterative correlation-based equalizer processes two data blocks at a time.

17. The system of claim 11, wherein the first correlation-based equalizer component comprises:
a passive phase conjugation component operative to pre-process the received sound transmissions of the current data block according to the estimated channel impulse response associated with the previous data block; and
a decision feedback equalizer component operative to produce the initial estimated symbols of the current data block based at least partially on the pre-processed sound transmissions using a set of tap coefficients associated with the previous data block.

18. The system of claim 17, wherein the second correlation-based equalizer component comprises:
a second passive phase conjugation component operative to pre-process the received sound transmissions of the current data block according to the estimated channel impulse response associated with the current data block; and
a second decision feedback equalizer component operative to produce the re-estimated symbols of the current data block based at least partially on the pre-processed sound transmissions using the set of tap coefficients associated with the current data block.

19. The system of claim 18, wherein the iterative correlation-based equalizer processes two data blocks at a time.

20. The system of claim 11, wherein the iterative correlation-based equalizer processes two data blocks at a time.
